(19) United States
(12) Patent Application Publication
(10) Pub. No.: US 2021/0383231 A1
(43) Pub. Date: Dec. 9, 2021

(54) TARGET CROSS-DOMAIN DETECTION AND UNDERSTANDING METHOD, SYSTEM AND EQUIPMENT AND STORAGE MEDIUM

(71) Applicant: CHANG'AN UNIVERSITY, Xi'an (CN)

(72) Inventors: Zhanwen LIU, Xi'an (CN); Xing FAN, Xi'an (CN); Tao GAO, Xi'an (CN); Xi ZHANG, Xi'an (CN); Youquan LIU, Xi'an (CN); Runmin WANG, Xi'an (CN); Ting CHEN, Xi'an (CN); Haigen MIN, Xi'an (CN); Yuande JIANG, Xi'an (CN); Pengpeng SUN, Xi'an (CN); Shan LIN, Xi'an (CN); Songhua FAN, Xi'an (CN)

(21) Appl. No.: 17/405,468

(22) Filed: Aug. 18, 2021

(30) Foreign Application Priority Data
Aug. 20, 2020 (CN) 202010845641.2

(51) Int. Cl. G06N 3/08; G06N 3/04; G06N 3/063; G06K 9/62; G06K 9/46

(52) U.S. Cl. CPC G06N 3/08; G06N 3/0472; G06N 3/063; G06K 9/4671; G06K 9/6251; G06K 9/6282; G06K 9/6215; G06K 9/6219

(57) ABSTRACT

The present invention discloses a target cross-domain detection and understanding method, system and equipment and a storage medium. Through spatial probability control and salient point pooling and in conjunction with a coupling relationship between a coding position probability and image features, diagonal vertexes of a target candidate frame are efficiently located, and network complexity is simplified so as to meet application needs for actual detection; through cross-domain guiding semantic extraction and knowledge transfer, an inclusion relation between target depth visual features and guiding semantics for different domains is explored, network training is guided, and cross-domain invariant features are extracted to enhance the cross-domain perception of a model; and by analyzing a target notability degree, a semantic hierarchy cross-domain perception mapping effect and a back propagation mechanism are explored, and a problem of accuracy in notable target prediction and guiding semantic understanding under a specific intention is solved.

### CROSS-REFERENCE TO RELATED APPLICATIONS

This application claims the benefit of priority from Chinese Patent Application No. 202010845641.2, filed on Aug. 20, 2020. The content of the aforementioned application, including any intervening amendments thereto, is incorporated herein by reference in its entirety.

### TECHNICAL FIELD

The present invention belongs to the field of target detection and recognition, and relates to a target cross-domain detection and understanding method, system and equipment and a storage medium.

### BACKGROUND OF THE PRESENT INVENTION

With the development of computer technology and the extensive popularization of computer vision principles, target detection and recognition are applied to many aspects: intelligent monitoring systems, military-industrial target detection, medical operation tracking and traffic sign calibration. For the same aspect, the entities designed by different countries are expressed as different colors and graphs, but most of the indicative guiding semantics are the same; and different places of the same country may make slight changes to the design, namely, there are differences in shape, size and geometrical change within the same domain, but the indicative guiding role is also kept unchanged.

In the same scene, a target is of different degrees of importance in an indicative guiding effect on a participant. In a complex scene that needs to process multiple targets in real time, selective detection and recognition of the target is particularly important. Taking an application of target detection in traffic signs as an example, with the expansion of urban construction scale and infrastructure functions, there are often multiple traffic sign posts on both sides of a road or within a field of view of 50-100 m, and each traffic sign post has multiple traffic signs. In general, each road user differs in a need for the guidance of the traffic signs and in an attention degree on the traffic signs according to respective proceeding intention. The road user quickly scans various traffic signs with a human visual system to find a traffic sign that is highly relevant to the proceeding intention, namely, a notable traffic sign; and corresponding guiding semantics can be quickly extracted to guide a current traffic behavior or serve as a basis for deciding a next-moment traffic behavior.

An existing target detection and recognition algorithm based on deep learning does not have an ideal generalization ability for different datasets and is passive in detecting all targets in an image, without considering the effectiveness of the target on the users with different intentions and an impact on a notability degree. For a specific application of target detection and recognition in automatic drive, taking a traffic sign obtained by an existing traffic sign detection and recognition method as an input of a decision making system of automatic drive will increase the difficulty and redundancy of fusion and result in numerous unnecessary expenses of system calculation.

Thus, for different target domains, it is a difficult key problem in target detection and understanding study based on a convolutional neural network to efficiently perceive a notable target related to the current intention and understand corresponding guiding semantics.

### SUMMARY OF THE PRESENT INVENTION

A purpose of the present invention is to overcome the technical problems of great difficulty and high expenses of applying a target cross-domain detection and understanding method in practical system calculation in the above prior art, and to provide a target cross-domain detection and understanding method, system and equipment and a storage medium.

To achieve the above purpose, the present invention is implemented by the following technical solution:

A target cross-domain detection and understanding method based on attention estimation, including the following steps:

Step 1: constructing a lightweight convolutional neural network by using a spatial probability control layer as an input image channel and in conjunction with an edge salient cross point pooling layer;

Step 2: performing cross-domain modeling by use of a guiding semantic hierarchy inclusion relation, and extracting and expressing the guiding semantics of a target cross-domain training sample; constructing a tree structure with the guiding semantic hierarchy inclusion relation based on a deep inclusion relation between the guiding semantics, which is used for NEGSS-NET cross-domain enhanced perception under a specific intention;

Step 3: establishing a mapping prediction network between visual features and guiding semantics in a complex scene based on the tree structure of step 2, acquiring the specific process and definition of feature mapping as well as the specific structure and definition of a mapping network, and realizing mapping from an image visual feature space to a semantic space; and

Step 4: defining a joint guiding semantic loss and estimation of an intention-based target notability degree, and acquiring an intention-based notability degree.

Preferably, the step 1 specifically includes:

Step 11: establishing a positional probability control channel with a multi-scale spatial probability division method; and

Step 12: performing convolution through a feature map output by Mobilenet v3 to obtain F={fₗ, fᵣ, fₜ, f_{b}}, then performing salient point pooling, and acquiring a heat map for diagonal vertex prediction, a bias and an embedded value, to obtain the lightweight convolutional neural network.

Further preferably, the process of establishing a positional probability control channel in the step 11 specifically includes:

Step 111: analyzing the statistical features of a transcendental position of the target, and pretreating the solutions of sample images in a dataset as W*H; then counting the times k of a target position appearing within a pixel point m through Σᵢ₌₁ⁱ⁼ⁿφₘ(i), wherein the target number is i={1, 2, . . . , n}, and φₘ(i) represents a counter of a target i appearing at the pixel point m;

$${φ}_{m} ( i ) = \{ \begin{matrix}1 & the i th target appears at the pixel point m \\ 0 & the i th target does not appear at the pixel point m\end{matrix} \qquad ( 1 )$$

finally, calculating with pₘ=k/n to obtain a probability of the target appearing at the pixel point m;

Step 112: dividing each input sample image into multiple same regions by use of different scales; and

Step 113: calculating the sum of probability values of the target appearing at all pixel points within the same region in the step 112, as a probability value of each pixel point in this region; then, adding the probability value of each pixel point in different regions and normalizing, and then establishing a spatial probability control template based on the probability statistics of a target center point.

Further preferably, the process of salient point pooling in the step 12 specifically includes:

At first, assuming that the sizes of feature maps fₗ and f are W*H, and the feature values at a pixel position (i, j) are f_{l(i, j)} and f_{t(i, j)} respectively; then, calculating a maximum value dᵢⱼ between f_{l(i, j)} and f_{l(i, j+Step)} according to formula (2), and calculating a maximum value gᵢⱼ between f_{t(i, j)} and f_{t(i, j+Step)} according to formula (3),

$$\begin{matrix}{d}_{ij} = \{ \begin{matrix}max ( {f}_{l ( i , j )} , {f}_{l ( i + 1 , j )} , … , {f}_{l ( i , j + Step )} ) & if j < W \\ {f}_{l ( i , W )} & otherwise\end{matrix} & ( 2 ) \\ {g}_{ij} = \{ \begin{matrix}max ( {f}_{t ( i , j )} , {f}_{t ( i - 1 , j )} , … , {f}_{t ( i - Step , j )} ) & if i < H \\ {f}_{t ( H , j )} & otherwise\end{matrix} & ( 3 ) \\ {h}_{( i , j )} = {d}_{ij} + {g}_{ij} & ( 4 )\end{matrix}$$

finally, adding the two maximum values a the pixel position i, j according to formula (4) to obtain a feature value h_{(i, j)}, as a final feature value at the pixel position (i, j).

Preferably, the step 2 specifically includes:

Step 21: acquiring a target class label;

Step 22: performing semantic space mapping on target samples and class text labels involved in multiple domains, to obtain corresponding semantic class vectors;

Step 23: forming superclass vectors in a target guiding semantic vector space, and constructing a guiding semantic hierarchy tree by taking the superclass vectors as the nodes of the guiding semantic hierarchy tree; and

Step 24: forming mapping between a target bottom-layer visual feature space and a guiding semantic space based on network training of the guiding semantic hierarchy tree.

Preferably, the step 23 specifically includes:

Expressing a correlation between the vectors in the target guiding semantic vector space with L1 distance or cosine similarity; forming superclass vectors in the target guiding semantic vector space with a clustering algorithm according to the similarity, as the nodes of the guiding semantic hierarchy tree; and performing preliminary visualization on a clustered class label term vector by using a method of visualizing t-SNE dimensionality reduction.

Preferably, in the step 24, the superclass vectors are subjected to iterative clustering to form higher-level superclass vectors, so as to form the guiding semantic hierarchy tree.

A target cross-domain detection and understanding system based on attention estimation, including:

A convolutional neural network module, which is used for constructing a lightweight convolutional neural network by using a spatial probability control layer as an input image channel and in conjunction with an edge salient cross point pooling layer;

A semantic tree module, which is used for performing cross-domain modeling on a guiding semantic hierarchy inclusion relation, and constructing a tree structure with the guiding semantic hierarchy inclusion relation; and

A notability degree estimation module, which is used for defining a joint guiding semantic loss and estimation of an intention-based target notability degree.

Computer equipment includes a memory, a processor, and a computer program stored in the memory and capable of running on the processor, wherein the processor implements the steps of the target cross-domain detection and understanding method based on attention estimation when executing the computer program.

A computer-readable storage medium stores a computer program, wherein when the computer program is executed by the processor, the steps of the target cross-domain detection and understanding method based on attention estimation are implemented.

Compared with the prior art, the present invention has the following beneficial effects:

The present invention discloses the target cross-domain detection and understanding method. The regional weight can be partially reduced through spatial probability control and salient point pooling and by taking a spatial probability control layer as an input image channel, and an edge salient cross point pooling layer can help a network to better locate a target point; through cross-domain guiding semantic extraction and knowledge transfer, an inclusion relation between target depth visual features and guiding semantics for different domains is explored, network training is guided, and cross-domain invariant features are extracted to enhance the cross-domain perception of a model; and by analyzing a target notability degree, a semantic hierarchy cross-domain perception mapping effect and a back propagation mechanism are explored, and a problem of accuracy in notable target prediction and guiding semantic understanding under a specific intention is solved. The method of the present invention can precisely simulate a process of importance scanning and semantic judgment of a visual system on a target, and the result will guide current behavior or serve as a basis for deciding a next-moment behavior, thereby enhancing environmental visual perception ability and active safety. The method of detecting and understanding a notable target according to a specific intention is efficient, objective and comprehensive, and can effectively enhance the environmental visual perception ability and active safety. Meanwhile, in conjunction with a coupling relationship between a coding position probability and image features, diagonal vertexes of a target candidate frame are efficiently located, network complexity is simplified, the difficulty and redundancy of fusion are avoided, the expenses of system calculation are saved, and the application needs for actual detection can be met.

Further, a position predicted by a diagonal vertex prediction heat map is corrected with a bias, and it is judged whether the upper left vertex and the lower right vertex come from the same target candidate frame according to a defined embedded threshold; and if the upper left vertex and the lower right vertex exceed the threshold, which indicates that they come from the same target candidate frame, then a redundant frame is removed through soft-NMS. By arranging a salient point pooling module behind the last-layer bottleneck of Mobilenet v3, the computing efficiency can be improved.

Further, a positional probability control channel is established with a multi-scale spatial probability division method. Since the rules of a target appearing at a position in a scene graph are traceable, a purpose of involving this channel is to count a probability of the target appearing at different regions of the image, and the channel is input into the network as a fourth input layer. In this way, the weight of a region with a small probability of target appearing is reduced, and the network complexity is lowered. The salient point pooling module outputs a diagonal vertex prediction heat map, a bias and an embedded value, thereby avoiding the network redundancy caused by the use of an anchor.

Further, the positional probability control channel unifies the input images as H*W, to facilitate network post-processing. An image is divided into different regions for statistics, in order to take an average probability and improve the accuracy of the statistical result.

Further, the salient point pooling module is arranged because the size of a target needing detection in a specific industry has traceable rules. Taking the detection of a traffic sign as an example, the pixels of the traffic sign appearing in an image are within 128 px*128 px, so only some of the pixels are chosen in a pooling process, with no need to process the whole image, thereby greatly reducing the operating cost of the system of the present invention.

Further, a guiding semantic hierarchy tree is constructed, namely, the targets in different domains are almost consistent in semantic expression. The formation of the guiding semantic hierarchy tree can provide help for cross-domain detection and help a user to understand current situation.

Further, superclass vectors are constructed, that is, to extract a base class as a higher class; and when a detector does not detect a base-class target, the superclass vectors will offer help to the detection result. The construction of the superclass vectors can increase the recall ratio of cross-domain detection.

The present invention also discloses a target cross-domain detection and understanding system based on attention estimation, which includes three modules: a convolutional neural network module, which is used for constructing a lightweight convolutional neural network by using a spatial probability control layer as an input image channel and in conjunction with an edge salient cross point pooling layer; a semantic tree module, which is used for performing cross-domain modeling on a guiding semantic hierarchy inclusion relation, and constructing a tree structure with the guiding semantic hierarchy inclusion relation; and a notability degree estimation module, which is used for defining a joint guiding semantic loss and estimation of an intention-based target notability degree. The system of the present invention is applied to automatic drive, and can solve the technical problems of great difficulty and high expenses of applying current target cross-domain detection and understanding method in practical system calculation, and can remarkably save the cost on the premise of guaranteeing correct recognition of road traffic signs.

### BRIEF DESCRIPTION OF THE DRAWINGS

FIG. 1 is a general framework diagram of the present invention;

FIG. 2A-2B are schematic diagrams of spatial probability control, in which FIG. 2A shows the probability statistics of target appearing positions in a dataset, and FIG. 2B shows a process of forming a positional probability channel;

FIG. 3 is a schematic diagram of a salient point pooling module;

FIG. 4 is a schematic diagram of edge salient cross point pooling (note: W=H=8, Step=3);

FIG. 5 is a schematic diagram of clustering results of class label term vectors;

FIGS. 6A and 6B show guiding semantic hierarchy trees;

FIG. 7 is a schematic diagram of a method of mapping NEGSS-NET guiding semantics;

FIG. 8 is a schematic diagram of a guiding semantic mapping network; and

FIG. 9 is a schematic diagram of a process of adding a semantic tree.

### DETAILED DESCRIPTION OF THE PRESENT INVENTION

The present invention is further described in detail below in conjunction with drawings.

### Embodiment 1

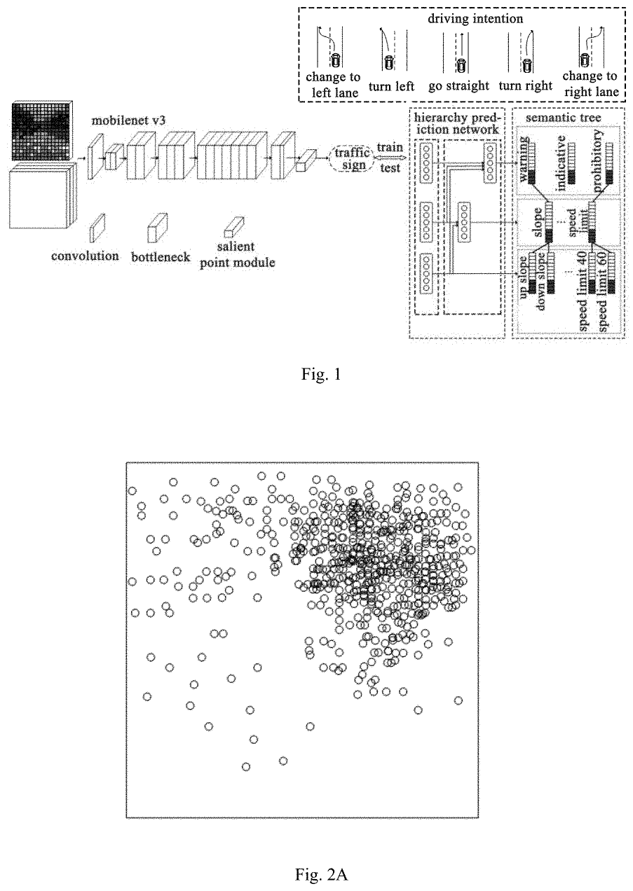

As shown in FIG. 1, the target cross-domain detection and understanding method based on attention estimation of the present invention includes the following specific steps:

Step 1: constructing an efficient lightweight convolutional neural network for an application of target practical detection by using a lightweight network mobilenet v3 as a backbone network and introducing a spatial probability control layer and an edge salient cross point pooling layer, as shown in FIG. 1;

The step 1 includes step 11 and step 12:

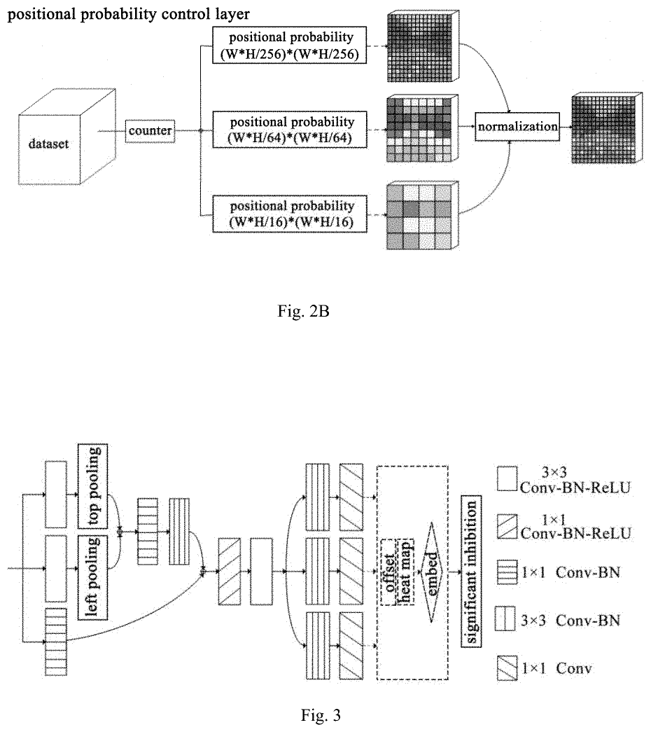

Step 11: proposing a multi-scale spatial probability division method, and constructing a positional probability control channel, as shown in FIG. 2, which specifically includes:

Step 111: analyzing the statistical features of a transcendental position of a target, as shown in FIG. 2-1, and calculating a probability of the target appearing at a pixel point m, specifically by:

First, analyzing the statistical features of the transcendental position of the target, and pretreating the resolutions of sample images in a dataset as W*H; then counting the times k of a target position appearing within the pixel point m through Σᵢ₌₁ⁱ⁼ⁿφₘ(i), wherein the target number is i={1, 2, . . . , n}, and φₘ(i) represents a counter of a target i appearing at the pixel point m, as shown in a formula (1),

$${φ}_{m} ( i ) = \{ \begin{matrix}1 & the i th target appears at the pixel point m \\ 0 & the i th target does not appear at the pixel point m\end{matrix} \qquad ( 1 )$$

Finally, calculating with pₘ=k/n to obtain a probability of the target appearing at the pixel point m;

Step 112: dividing the images into 16, 64 and 256 square regions respectively with scales of different sizes, wherein the pixel points included in each square region are l₁=W*H/16, l₂=W*H/64 and l₃=W*H/256, as shown in FIG. 2-2.

As an example shown in Table 1, an image is divided into 16 regions of the same size, and the probability of a target appearing in each region is counted (note: data in Tables 1 and 2 are only used for demonstrative illustration, not from practical use).

TABLE 1
Probabilities of a target appearing
in 16 regions of the same size

| | | | |
|---|---|---|---|
| 0.02 | 0.03 | 0.005 | 0.2 |
| 0.05 | 0.05 | 0.2 | 0.25 |
| 0.01 | 0.02 | 0.08 | 0.02 |
| 0.005 | 0.002 | 0.006 | 0.007 |

Four small regions of the above 16 regions are merged into a big region, and further calculation is performed to obtain Table 2.

TABLE 2
Appearing probabilities of the
target after the region merging

| | |
|---|---|
| 0.15 | 0.7 |
| 0.37 | 0.113 |

Step 113: establishing a spatial probability control template based on the probability statistics of a target center point, specifically:

First, calculating the sum of probability values of the target appearing at all pixel points within the same square region, as a probability value of each pixel point in this square region; then, adding the probability values of each pixel point in three divisions and normalizing; and finally, establishing the spatial probability control template based on the probability statistics of a target center point.

Step 12: introducing a salient point pooling module, and acquiring the prediction heat maps, biases and embedded vectors of two diagonal vertexes of a candidate frame, as shown in FIG. 3, specifically including:

Step 121: performing convolution on the feature maps output by mobilenet v3 to obtain f={fₗ, fᵣ, fₜ, f_{b}}, then performing salient point pooling, specifically:

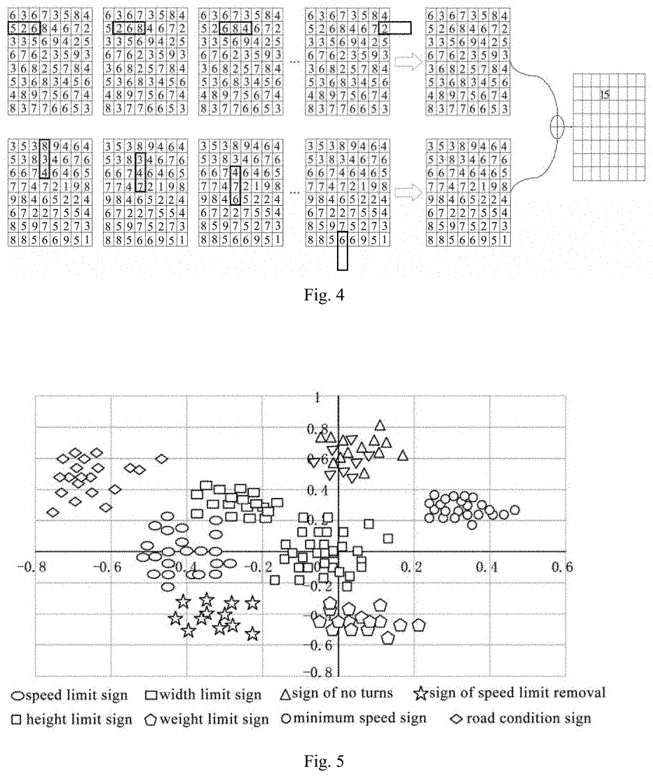

At first, assuming that the sizes of feature maps fᵢ and f are W*H, and the feature values at a pixel position (i, j) are f_{l(i, j)} and f_{t(i, j)} respectively; then, calculating a maximum value dᵢⱼ between f_{l(i, j)} and f_{l(i, j+Step)}, as shown in a formula (2), and a maximum value gᵢⱼ between f_{t(i, j)} and f_{t(i, j+Step)} as shown in a formula (3) respectively; and finally, adding the two maximum values at the pixel position (i, j) to obtain a feature value h_{(i, j)}, as a final feature value at the pixel position (i, j), as shown in FIG. 4.

$$\begin{matrix}{d}_{ij} = \{ \begin{matrix}max ( {f}_{l ( i , j )} , {f}_{l ( i + 1 , j )} , … , {f}_{l ( i , j + Step )} ) & if j < W \\ {f}_{l ( i , W )} & otherwise\end{matrix} & ( 2 ) \\ {g}_{ij} = \{ \begin{matrix}max ( {f}_{t ( i , j )} , {f}_{t ( i - 1 , j )} , … , {f}_{t ( i - Step , j )} ) & if i < H \\ {f}_{t ( H , j )} & otherwise\end{matrix} & ( 3 )\end{matrix}$$

Step 122: outputting, by the salient point pooling module, a diagonal vertex heat map, a bias and an embedded value, correcting a position predicted by the heat map with the bias, and judging judged whether the upper left vertex and the lower right vertex come from the same target candidate frame according to a defined embedded threshold; and if the upper left vertex and the lower right vertex exceed the threshold, which indicates that they come from the same target candidate frame, then removing a redundant frame through soft-NMS, wherein the salient point pooling module is arranged behind the last-layer bottleneck of Mobilenet 3.

Step 2: performing cross-domain modeling on a guiding semantic hierarchy inclusion relation while establishing a mapping prediction network between visual features and guiding semantics in a complex scene; The step 2 includes step 21 and step 22:

Step 21: generating a vectorized expression of cross-domain training data label terms, and realizing extraction and expression of the guiding semantics of a target cross-domain training sample, including the following specific steps:

Step 211: acquiring a target class label of finer granularity, specifically:

With a traffic sign dataset as an example, studying existing traffic sign datasets, removing the datasets with relatively few classes, arranging and extending the classes of existing traffic sign datasets including about 50 classes, ((Belgium, 62 classes), LISA (USA, 47 classes), GTSDB (Germany, 43 classes), TT-100k (China, 45 classes) and CCTSDB (China, 48 classes)), and refining the class label and setting corresponding class text labels, to obtain a traffic sign class label of finer granularity.

Step 212: performing semantic space mapping on a target sample class text label involved in multiple domains, to obtain corresponding semantic class vectors, specifically:

Processing a large corpus collected through media such as Wikipedia, Twitter and Google News with a natural language, mapping a target sample class text label y involved in multiple domains for a semantic space S through models such as Word2Vec and Glove (S is composed of the term vectors acquired from the large corpus), to obtain a corresponding semantic class vector s(y)∈S≡R^{V}, wherein it should be noted that since the target class text label includes words and phrases at the same time, a problem in expressing a phrase vector is solved by adopting a method of SIF [A simple but tough-to-beat baseline for sentence embeddings, 2016], in which all word vectors in the phrase are subjected to weighted average, to finally obtain corresponding expression of the phrase vector, as the semantic class vector.

Step 22: exploring a deep inclusion relation between the guiding semantics, and constructing a tree structure with the guiding semantic hierarchy inclusion relation, to realize NEGSS-NET cross-domain enhanced perception under a specific proceeding intention. Preferably, the step 22 includes the following specific steps:

Step 221: forming superclass vectors in a target guiding semantic vector space, and using the superclass vectors as the nodes of the guiding semantic hierarchy tree, specifically:

Expressing a correlation between the vectors in the target guiding semantic vector space with L1 distance or cosine similarity; forming superclass vectors in the target guiding semantic vector space with a clustering algorithm according to the similarity, as the nodes of the guiding semantic hierarchy tree; and performing preliminary visualization on a clustered class label term vector by using a method of visualizing t-SNE dimensionality reduction, as shown in FIG. 5.

Step 222: constructing a guiding semantic hierarchy tree, specifically by:

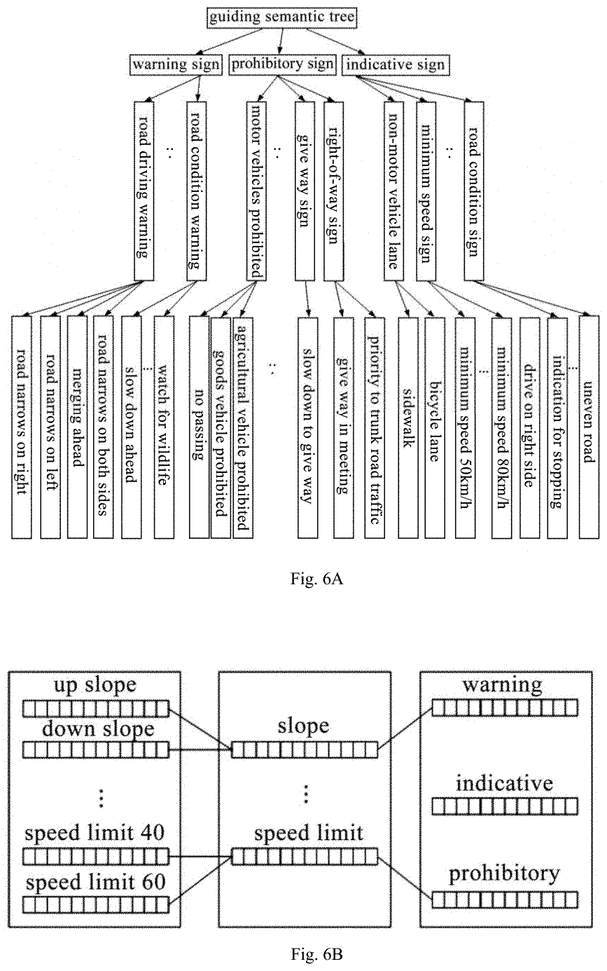

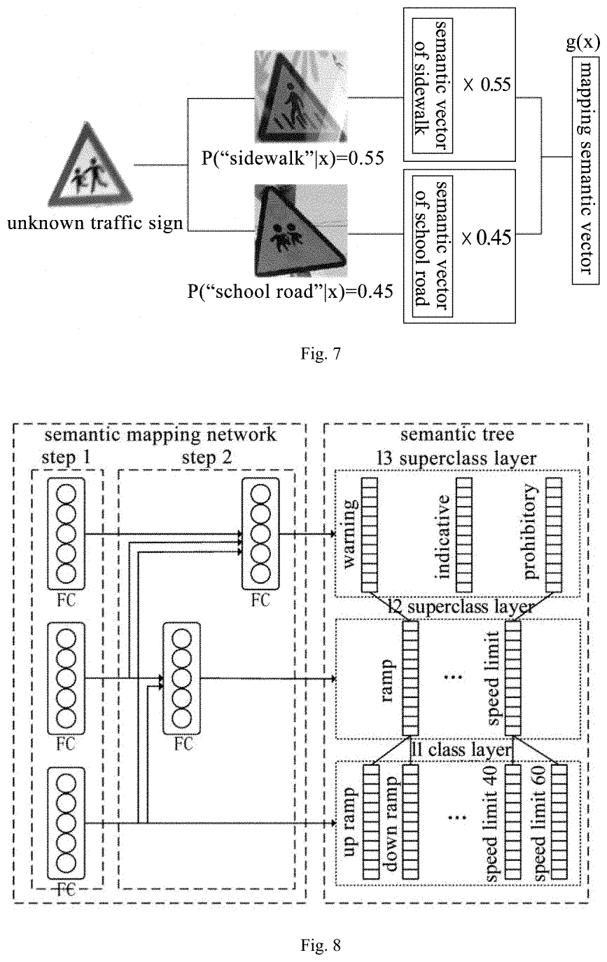

Performing iterative clustering on the superclass vectors to form higher-level superclass vectors, so as to form the guiding semantic hierarchy tree. Taking a traffic sign as an example, the highest level includes three top-level nodes in total, which are defined as a warning sign, a prohibitory sign and an indicative sign respectively, and finally, the guiding semantic hierarchy tree is constructed, as shown in FIG. 6.

Step 223: performing network training based on the guiding semantic hierarchy tree, and transforming a problem of mapping a domain invariant visual feature space into a problem of mapping a target bottom-level visual feature space and a guiding semantic space.

Step 3: acquiring estimation of an intention-based target notability degree. The step 3 includes the following specific steps:

Step 31: constructing a guiding semantic mapping network, in which multiple fully-connected layers are cascaded to construct a mapping network, to realize mapping from an image visual feature space to a semantic space, as shown in FIG. 7.

The specific process and definition of feature mapping are as follows:

First, a softmax classifier pₜₑₛₜ is trained based on a training dataset Dₜᵣₐᵢₙ, and a class label with the highest confidence is obtained through softmax, as shown in a formula (4):

$$\hat{y} ( x , 1 ) = {arg max}_{y ∈ Y} {p}_{train} ( y \vert x ) \qquad ( 4 )$$

wherein pₜₑₛₜ(y|x) represents the probability of an input image x belonging to a certain class label y; then, the guiding semantic mapping network will output multiple class labels with the highest confidence; ŷ(x,m) represents m class labels with the highest confidence provided by the classifier pₜₑₛₜ according to the input image x; and finally, based on the M class labels with the highest confidence predicted by the classifier pₜₑₛₜ, the semantic vectors corresponding to the M category labels with the highest confidence are subjected to weighted average by taking the confidence value of each class label as its weight, and NEGSS-Net maps the visual features of the input image x into corresponding semantic vectors g(x), as shown in FIG. 5.

$$g ( x ) = \frac{1}{z} {\sum }_{m = 1}^{M} {p}_{test} ( \hat{y} ( x , m ) \vert x ) \cdot s ( \hat{y} ( x , m ) ) \qquad ( 5 )$$

wherein Z=Σₘ₌₁^{M}pₜₑₛₜ(_{ŷ}(x, m)|x) is a normalization factor, M represents the maximum number of the semantic vectors that are considered at a time, and s(_{ŷ}(x,m) represents the semantic vectors corresponding to the m class labels with the highest confidence predicted by NEGSS-Net for the image x.

The specific structure and definition of the mapping network are as follows:

With the mapping method of the step 311, the guiding semantic mapping network predicts a target superclass label through two steps. The first step is predicting the class labels on different class and superclass layers respectively, as shown in the left dashed box of FIG. 8; and the second step is coding a semantic hierarchy structure into a superclass label prediction process, that is, combining the prediction results of the classes on current layer and bottom layer or the low-layer superclass in the first step, as shown in the right dashed box of FIG. 8, wherein “FC” represents a fully-connected layer.

In the first step, three unshared fully-connected layers having a softmax layer are used to give a target sample, and each fully-connected layer will provide the probability distribution of its class or superclass on corresponding layer. In the second step, two unshared fully-connected layers are used to predict a class label on corresponding superclass layers respectively. In order to incorporate a hierarchy structure into the successive fully-connected layers, the output vectors on current layer and a lower layer in the first step are correspondingly superposed, as an input of a fully-connected network in the second step of corresponding layer. For the bottom superclass layer (layer l2), the outputs of the bottom two layers in the first step are combined as its input, as shown in formula (6),

\hat{p}₁₂= [symbol] (pₗ₁⊕pₗ₂) (6)

wherein pₗ₁ represents a prediction result of a class layer in the first step, and pₗ₂ represents a prediction result of the bottom superclass layer in the first step. ⊕ is a channel splicing operator. [symbol] represents a forward propagation step of the fully-connected network on layer l2 in the second step, and \hat{p}ₗ₂ represents a final predicated probability distribution of possible superclass labels on the second layer of corresponding semantic hierarchy tree. From this, a superclass label corresponding to a layer li=(i=2, . . . , n+1), as shown in formula (8), can be inferred based on a result of a layer lj(j≤i) in the first step, as shown in formula (7); M superclass labels with the highest confidence are selected from the softmax results calculated on each fully-connected layer in the second step by using a part a mapping method (formula (7)); the semantic vectors corresponding to the M superclass labels are subjected to weighted average by using a predicted probability corresponding to each superclass label as a weight, and its result is a superclass semantic vector obtained by mapping the image visual features; and a nearest neighbor algorithm is implemented in a semantic space to obtain a final predicted superclass label. The cascade fully-connected layers of an unshared weight, as an extension taking mobilenetv3 as a backbone network, are cascaded to form NEGSS-Net. Based on this, a loss function of a hierarchy prediction network is defined, as shown in formula (9).

pₗ₁= [symbol] (ƒ(x)),i=, . . . ,n+1 (7)

\hat{p}ₗ₂ [symbol] (⊕ⱼ₌₁ⁱpₗ₂),i=2, . . . ,n+1 (8)

[symbol]

_{hierarchy}(x,Y)=L_{cls}(yₗ₁,pₗ₁)+Σᵢ₌₁ⁿ⁺¹λᵢ [symbol] _{cls}(yₗᵢ,\hat{p}ₗᵢ) (9)

wherein f(⋅) represents a forward propagation step for extraction of image features of the NEGSS-NET backbone network; [symbol] and [symbol] represent forward propagation steps of the operations in the first step and the second step by the fully-connected network on the layer li; [symbol] _{cls} is a cross entropy loss function; [symbol] _{cls}(yₗᵢ,\hat{p}ₗᵢ) is a cross entropy loss function for classification prediction of a bottom-layer class label of a semantic tree; Σᵢ₌₂ⁿ⁺¹λᵢ [symbol] (yₗᵢ,\hat{p}ₗᵢ) is a cross entropy loss function for classification prediction of all superclass labels; and Xi represents a loss weight.

Step 32: defining estimation of an intention-based target notability degree, including the following steps:

Step 321: estimating an intention-based notability degree, specifically by:

With a traffic sign as an example, at first, describing a proceeding intention with a 5D vector, which is referred to as an intention feature fᵢₙₜ=[lc, lt, s, rt, rc], wherein lc, lt, s, rt, rc represent five proceeding intentions respectively: turn left, change to left lane, go straight, change to right lane and turn right; and then, performing feature fusion on the intention feature and a target visual feature: ƒ_{fusion}=ƒ(x)⊕ƒᵢₙₜ, where f(x) represents a visual feature extracted by a target through the NEGSS-Net backbone network; represents a channel splicing operator; f_{fusion} represents the fused feature; and finally, inputting the f_{fusion} into the guiding semantic mapping network, and predicting, by NEGSS-Net, the weight of an intention-based notability degree of the traffic sign and a target class label, wherein a loss function of the intention-based notability degree of the traffic sign is defined as formula (10):

[symbol]

_{notable}(z,\hat{z})=−[z log \hat{z}+(1−z)log(1−z)] (10)

wherein z represents a real notability degree of a target traffic sign under specific proceeding intention; and \hat{z} represents the notability degree of current traffic sign predicted by NEGSS-Net based on the generated fusion feature f_{fusion}.

Step 322: defining a joint guiding semantic loss, specifically:

At first, eliminating, by NEGSS-Net, the semantic information with low importance, and splicing the remaining important target semantic vectors, to form a semantic vector v_{predict} of a joint guiding semantic recommendation, as shown in formula (11):

v_{predict}=ₖ₌₁^{K}aₖ·sₖ (11)

wherein K represents the total number of targets in a picture; sₖ represents a semantic vector corresponding to each individual target; ⊕ represents a channel connector; aₖ is a binary mask set according to the predicted target notability degree, which is used for filtering the guiding semantics of a traffic sign with a low notability degree under current intention; for a notable target under current intention, aₖ=1; otherwise, aₖ=0; and in this way, the splicing of all important target semantic vectors under current intention can be realized. V_{label} is a semantic vector corresponding to a real joint guiding semantic recommendation; and based on this, a joint guiding semantic loss [symbol] _{guide} is defined as a hinge loss with respect to v_{predict} and v_{label}, as shown in formula (12):

$${ℒ}_{guide} ( {v}_{predict} , {v}_{label} ) = {\sum }_{j \neq label} max ( 0 , margin - {v}_{label} \cdot {v}_{predict}^{T} + {v}_{j} \cdot {v}_{predict}^{T} ) \qquad ( 12 )$$

wherein v_{label} is a row vector, representing a semantic vector corresponding to a real joint guiding semantic recommendation; v_{predict} is a row vector, representing a semantic vector corresponding to a joint guiding semantic recommendation predicted by a model; vⱼ is a semantic vector corresponding to all wrong guiding semantic recommendations; and margin is a constant equal to 0.1. The obtained feature vector of the joint guiding semantic recommendation is mapped into corresponding text information; and finally, NEGSS-Net provides a joint semantic guiding recommendation for all notable targets based on current intention.

In conclusion, a loss function of NEGSS-Net under a specific intention is defined as three parts, as shown in formula (13):

[symbol]

_{final}= [symbol] _{hierarchy}(x,Y)+ [symbol] _{notable}(z,\hat{z})± [symbol] _{guide}(v_{predict},v_{label}) (13)

wherein [symbol] _{hierarchy}(x, Y) is a loss of the guiding semantic mapping network; [symbol] _{notable}(z,\hat{z}) is a loss of the notability degree; and [symbol] _{guide}(v_{predict},v_{label}) is the joint guiding semantic loss.

To verify the effectiveness of the method of the present invention, a TT100K traffic sign dataset is trained and tested, wherein part 1 of the TT100K dataset includes 6,105 training pictures, 3,071 test pictures and 7,641 other pictures, covering different weathers and illumination changes. The training set is tested, and the test set is used for verification.

A. Parameter Setting

A model method is realized with keras+tensorflow, a model is pre-trained with the mobilenet network parameters of coco dataset, and the experimental environment involves intel Xeon CPU E5-2603 and TITAN Xpascal GPU. With respect to the setting of training parameters, an adam optimizer is selected to optimize the model, and the training parameters are: an input image size of 608×608, a batch size of 8 and a basic learning rate of 0.0001, which is adjusted by a ReduceLROnPlateau method of keras, with factor=0.1, and patience=3. An EarlyStopping method is adopted to assist in training.

In the present invention, a dataset is clustered with a kmeans algorithm to set initial frames for the network, in which 9 preset frames are set in total, with length-width sizes of [16, 18], [21, 23], [26, 28], [30, 35], [38, 40], [46, 50], [59, 64], [79, 85] and [117, 125]; and all frames predicted by the network are optimized by a NMS algorithm and then output.

B. Adding a Positional Channel

The network first adopts an ideology of mobilenet v3 plus FPN, and guarantees the detection precision of a small object on the premise of significantly reducing the size of the network parameters from 240 M of yolo3 to 27 M; and the lightweight network is more suitable to be carried by a mobile device and thus can be applied to a scene with limitations on hardware equipment such as automatic drive. Meanwhile, by introducing a positional channel to the network, the regional features are fully fused at a relatively small network depth, and experiments have discovered that accuracy can be improved on a basis of current network, as shown in Table 3.

TABLE 3
Comparison table of network
performance based on TT100K dataset

| Method | Dataset | Accuracy | FPS | Parameter |
|---|---|---|---|---|
| YOLO3 | TT100K | 0.75 | 8 | 240M |
| Mobilenet3 + FPN | TT100K | 0.72 | 12 | 27.1M |
| Mobilenet3 + FPN + PSE | TT100K | 0.74 | 11 | 27.2M |

Note:
PSE is a positional channel.

C. Adding a Semantic Tree

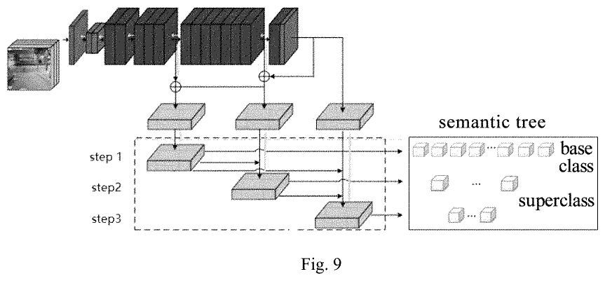

A semantic tree is creatively applied to the network so that the network predicts a superclass for an untrained class or performs supplementary prediction for a base class unbalanced in training. In this embodiment, the semantic tree has three layers in total, in which the bottom-layer classes are base classes of TT100K, including a total of 221 classes of various road signs; the middle-layer classes represent middle-layer superclasses obtained by fusing the base classes of TT100K, including a total of 27 classes; and the top layer represents highly fused top-layer superclass, including a total of 3 classes. Specifically, the base classes are predicted via the network, then the prediction results of the base classes result are fused with the output of a deep network branch to predict the middle-layer superclasses, and right then, the results of the middle-layer superclasses are fused with a deeper-layer network output to predict the top-layer superclasses, as shown in FIG. 9.

D. Results

Mobilenet v3 has an advantage of small quantity of network parameters, and FPN has the advantages of high speed and a small memory needed, thereby meeting a requirement for real-time performance in traffic sign detection. In this embodiment, the Mobilenet v3 is combined with the FPN, and the positional control layer and the semantic tree are added to propose NEGSS-Net. Based the TT100K traffic sign database, the accuracy of the NEGSS-Net is subjected to experimental verification. In addition, based on an untrained German FullIJCNN2013 dataset, the domain adaptability of NEGSS-Net is subjected to experimental verification, and the verification result indicates that the top-layer superclasses in NEGSS-Net can effectively make up for an inaccuracy in the prediction of base classes, thereby improving the accuracy; and the network can predict a traffic sign in the German FullIJCNN2013 dataset, thereby proving its ability of cross-domain detection.

If a channel estimation method based on a deep neural network of the present invention is implemented in a form of a software function unit and is sold or used as an independent product, the method can be stored in a computer-readable storage medium. Based on this understanding, the present invention can also implement the whole or part of the process in the method of the above embodiment by a computer program instructing relevant hardware; the computer program can be stored in a computer-readable storage medium; and when the computer program is executed by a processor, the steps in the embodiments of the above methods can be realized. The computer program includes computer program codes; and the computer program codes may be in a form of source codes, object codes, executable files and the like or in some intermediate forms. The computer-readable storage medium includes permanent and impermanent as well as mobile and immobile media, which can realize information storage through any method or technology. The information may be a computer-readable instruction, a data structure, a module of programs or other data. It should be noted that the content included in the computer-readable medium can be increased/decreased according to the requirements of the legislation and patent practice in the jurisdiction. For example, in some jurisdictions, the computer-readable medium does not include an electric carrier signal or a telecommunication signal according to the legislation and patent practice. The computer storage medium may be any available medium accessible to a computer or a data storage device, including but not limited to a magnetic memory (such as a floppy disk, a hard disk, a magnetic tape and a magnetic optical disk (MO)), an optical memory (such as CD, DVD, BD and HVD), and a semiconductor memory (such as ROM, EPROM, EEPROM, a nonvolatile memory (NANDFLASH) and a solid-state drive (SSD)).

An illustrative embodiment also provides computer equipment, including a memory, a processor, and a computer program stored in the memory and capable of running on the processor. The processor implements the steps of the channel estimation method based on a deep neural network when executing the computer program. The processor may be a central processing unit (CPU), or other general processor, a digital signal processor (DSP), an application specific integrated circuit (ASIC), a field-programmable gate array (FPGA), or other programmable logic device, a discrete gate or transistor logic device, a discrete hardware component and the like.

Those skilled in the art shall understand that the embodiments of the present invention can be provided as a method, a system or a computer program product. Therefore, the present invention may adopt a form of a complete hardware embodiment, a complete software embodiment or an embodiment combining software and hardware. Moreover, the present invention can adopt a form of a computer program product implemented on one or more computer-usable storage media (including but not limited to a disk memory, CD-ROM, an optical memory and the like.) including computer-usable program codes.

The present invention is described with reference to the flow charts of the methods, equipment (systems) and computer program products of the embodiments of the present invention. It shall be understood that each box in a block diagram and a combination with other boxes can be implemented by computer program instructions. These computer program instructions can be provided to the processor of a general-purpose computer, a special-purpose computer, an embedded processor or other programmable data processing equipment, to generate a machine so that the instructions executed by the processor of the computer or other programmable data processing equipment generate a device for implementing the specified functions in one or more processes of the flow chart.

These computer program instructions can also be stored in a computer-readable memory capable of guiding a computer or other programmable data processing equipment to work in a specific way, so that the instructions stored in the computer-readable memory generate a manufacture including an instruction device; and the instruction device realizes the specific functions in one or more boxes of a block diagram of the flow chart.

The above content is only intended to illustrate the technical idea of the present invention, and the protection scope of the present invention shall not be limited hereto. Any modifications made based on the technical solution according to the technical idea proposed by the present invention shall fall within the protection scope of the claims of the present invention.

We claim:

1. A target cross-domain detection and understanding method based on attention estimation, comprising the following steps:
Step 1: constructing a lightweight convolutional neural network by using a spatial probability control layer as an input image channel and in conjunction with an edge salient cross point pooling layer;
step 2: performing cross-domain modeling by use of a guiding semantic hierarchy inclusion relation, and extracting and expressing the guiding semantics of a target cross-domain training sample; constructing a tree structure with the guiding semantic hierarchy inclusion relation based on a deep inclusion relation between the guiding semantics, which is used for NEGSS-NET cross-domain enhanced perception under a specific intention;
step 3: establishing a mapping prediction network between visual features and guiding semantics in a complex scene based on the tree structure of step 2, acquiring the specific process and definition of feature mapping as well as the specific structure and definition of a mapping network, and realizing mapping from an image visual feature space to a semantic space; and
step 4: defining a joint guiding semantic loss and estimation of an intention-based target notability degree, and acquiring an intention-based notability degree.

2. The target cross-domain detection and understanding method based on attention estimation according to claim 1, wherein the step 1 specifically comprises:
step 11: establishing a positional probability control channel with a multi-scale spatial probability division method; and
step 12: performing convolution through a feature map output by Mobilenet v3 to obtain F={fₗ, fᵣ, fₜ, f_{b}}, then performing salient point pooling, and acquiring a heat map for diagonal vertex prediction, a bias and an embedded value, to obtain the lightweight convolutional neural network.

3. The target cross-domain detection and understanding method based on attention estimation according to claim 2, wherein the process of establishing a positional probability control channel in the step 11 specifically comprises:
step 111: analyzing the statistical features of a transcendental position of the target, and pretreating the solutions of sample images in a dataset as W*H; then counting the times k of a target position appearing within a pixel point m through Σᵢ₌₁ⁱ⁼ⁿφₘ(i), wherein the target number is i={1, 2, . . . , n}, and φₘ(i) represents a counter of a target i appearing at the pixel point m;
$${φ}_{m} ( i ) = \{ \begin{matrix}1 & the i th target appears at the pixel point m \\ 0 & the i th target does not appear at the pixel point m\end{matrix} \qquad ( 1 )$$
finally, calculating with pₘ=k/n to obtain a probability of the target appearing at the pixel point m;
step 112: dividing each input sample image into multiple same regions by use of different scales; and
step 113: calculating the sum of probability values of the target appearing at all pixel points within the same region in the step 112, as a probability value of each pixel point in this region; then, adding the probability value of each pixel point in different regions and normalizing, and then establishing a spatial probability control template based on the probability statistics of a target center point.

4. The target cross-domain detection and understanding method based on attention estimation according to claim 2, wherein the process of salient point pooling in the step 12 specifically comprises:
at first, assuming that the sizes of feature maps fᵢ and f are W*H, and the feature values at a pixel position (i, j) are f_{l(i, j)} and f_{t(i, j)} respectively; then, calculating a maximum value dᵢⱼ between f_{l(i, j)} and f_{l(i, j+Step)} according to formula (2), and calculating a maximum value gᵢⱼ between f_{t(i, j)} and f_{t(i, j+Step)} according to formula (3),
$$\begin{matrix}{d}_{ij} = \{ \begin{matrix}max ( {f}_{l ( i , j )} , {f}_{l ( i + 1 , j )} , … , {f}_{l ( i , j + Step )} ) & if j < W \\ {f}_{l ( i , W )} & otherwise\end{matrix} & ( 2 ) \\ {g}_{ij} = \{ \begin{matrix}max ( {f}_{t ( i , j )} , {f}_{t ( i - 1 , j )} , … , {f}_{t ( i - Step , j )} ) & if i < H \\ {f}_{t ( H , j )} & otherwise\end{matrix} & ( 3 ) \\ {h}_{( i , j )} = {d}_{ij} + {g}_{ij} & ( 4 )\end{matrix}$$
finally, adding the two maximum values at the pixel position (i, j) according to formula (4) to obtain a feature value h_{(i, j)}, as a final feature value at the pixel position (i, j).

5. The target cross-domain detection and understanding method based on attention estimation according to claim 1, wherein the step 2 specifically comprises:
step 21: acquiring a target class label;
step 22: performing semantic space mapping on target samples and class text labels involved in multiple domains, to obtain corresponding semantic class vectors;
step 23: forming superclass vectors in a target guiding semantic vector space, and constructing a guiding semantic hierarchy tree by taking the superclass vectors as the nodes of the guiding semantic hierarchy tree; and
step 24: forming mapping between a target bottom-layer visual feature space and a guiding semantic space based on network training of the guiding semantic hierarchy tree.

6. The target cross-domain detection and understanding method based on attention estimation according to claim 2, wherein the step 23 specifically comprises:
expressing a correlation between the vectors in the target guiding semantic vector space with L1 distance or cosine similarity; forming superclass vectors in the target guiding semantic vector space with a clustering algorithm according to the similarity, as the nodes of the guiding semantic hierarchy tree; and performing preliminary visualization on a clustered class label term vector by using a method of visualizing t-SNE dimensionality reduction.

7. The target cross-domain detection and understanding method based on attention estimation according to claim 2, wherein in the step 24, the superclass vectors are subjected to iterative clustering to form higher-level superclass vectors, so as to form the guiding semantic hierarchy tree.

8. A target cross-domain detection and understanding system based on attention estimation, comprising:
a convolutional neural network module, which is used for constructing a lightweight convolutional neural network by using a spatial probability control layer as an input image channel and in conjunction with an edge salient cross point pooling layer;
a semantic tree module, which is used for performing cross-domain modeling on a guiding semantic hierarchy inclusion relation, and constructing a tree structure with the guiding semantic hierarchy inclusion relation; and
a notability degree estimation module, which is used for defining a joint guiding semantic loss and estimation of an intention-based target notability degree.

9. Computer equipment, comprising a memory, a processor, and a computer program stored in the memory and capable of running on the processor, wherein the processor implements the steps of the target cross-domain detection and understanding method based on attention estimation of claim 1 when executing the computer program.

10. Computer equipment, comprising a memory, a processor, and a computer program stored in the memory and capable of running on the processor, wherein the processor implements the steps of the target cross-domain detection and understanding method based on attention estimation of claim 2 when executing the computer program.

11. Computer equipment, comprising a memory, a processor, and a computer program stored in the memory and capable of running on the processor, wherein the processor implements the steps of the target cross-domain detection and understanding method based on attention estimation of claim 3 when executing the computer program.

12. Computer equipment, comprising a memory, a processor, and a computer program stored in the memory and capable of running on the processor, wherein the processor implements the steps of the target cross-domain detection and understanding method based on attention estimation of claim 4 when executing the computer program.

13. Computer equipment, comprising a memory, a processor, and a computer program stored in the memory and capable of running on the processor, wherein the processor implements the steps of the target cross-domain detection and understanding method based on attention estimation of claim 5 when executing the computer program.

14. Computer equipment, comprising a memory, a processor, and a computer program stored in the memory and capable of running on the processor, wherein the processor implements the steps of the target cross-domain detection and understanding method based on attention estimation of claim 6 when executing the computer program.

15. Computer equipment, comprising a memory, a processor, and a computer program stored in the memory and capable of running on the processor, wherein the processor implements the steps of the target cross-domain detection and understanding method based on attention estimation of claim 7 when executing the computer program.

16. A computer-readable storage medium, storing a computer program, wherein when the computer program is executed by the processor, the steps of the target cross-domain detection and understanding method based on attention estimation of claim 1 are implemented.
